(19) United States
(12) Patent Application Publication
(10) Pub. No.: US 2016/0185047 A1
(43) Pub. Date: Jun. 30, 2016

(54) FOUR-IN-ONE THREE-DIMENSIONAL COPY MACHINE

(71) Applicant: AIO ROBOTICS, INC., Marina del Rey, CA (US)

(72) Inventors: Jens WINDAU, Los Angeles, CA (US); Chin-Kai CHANG, Los Angeles, CA (US); Christian SIAGIAN, Los Angeles, CA (US)

(21) Appl. No.: 14/909,735

(22) PCT Filed: Aug. 19, 2014
(86) PCT No.: PCT/US14/51728

§ 371 Date: Feb. 2, 2016

Related U.S. Application Data
(60) Provisional application No. 61/867,320, filed on Aug. 19, 2013.

(51) Int. Cl. B29C 67/00; G01B 11/00

(52) U.S. Cl. CPC B29C 67/0088; B29C 67/0055; B29C 67/0092; G01B 11/002; B33Y 30/00

(57) ABSTRACT

A three dimensional (3D) printing device or apparatus includes a housing, a rotatable surface contained within the housing that is configured to rotate in a substantially horizontal plane relative to a bottom surface of the housing. The 3D printing device further includes a vertical track in communication with the rotatable surface that guides the rotatable surface when the rotatable surface moves in a direction perpendicular to the substantially horizontal plane, a scanning module, including a camera and a laser, a printer head configured to deposit one or more layers of printing material on the rotatable surface, and a printer carriage configured to guide the printer head when the printer head deposits the one or more layers of printing material.

### CROSS-REFERENCE TO RELATED APPLICATIONS

The present application is a National Stage application of International Application No. PCT/US2014/051728, filed Aug. 19, 2014, which claims priority to U.S. Provisional Patent Application Ser. No. 61/867,320, filed on Aug. 19, 2014, the contents of each are herein incorporated by reference.

### BACKGROUND

1. Field of the Invention

The present disclosure relates generally to three-dimensional (3D) printing, and, more particularly, to a four-in-one 3D copy machine.

2. Description of the Related Art

Three-dimensional (3D) printing generally consists of producing 3D objects or models by a layering technique from computer data. For instance, 3D printing generally involves creating a 3D object by laying down successive layers of material, such as through print heads that deposit layer upon layer of building material into a desired shape, or by depositing a particulate material in thin layers and selectively printing a binder material onto the particulate to create the desired shape. 3D printing was originally useful for rapid prototyping of models, though because 3D models can be printed quickly and cheaply as compared to other techniques, 3D printing has quickly gained popularity.

### SUMMARY

Three dimensional (3D) printing, scanning, copying, and/or faxing devices, systems, and techniques are disclosed herein. As expressly used herein, the term “3D printing” generally may include or exclude any functionality such as 3D printing, 3D scanning, 3D copying, and/or 3D faxing. That is, although various devices, systems, and techniques are described as providing and/or employing combinations of such functionality, such functionality (including portions thereof) need not be combined, but instead may be employed independently (even exclusively) of other functionality.

According to one embodiment, a 3D printing device includes a housing, a rotatable surface contained within the housing and a vertical track in communication with the rotatable surface. The housing includes a bottom surface having an area greater than a top surface of the housing (e.g., a wider base) to provide stability for the housing when the housing rests on a surface (e.g., a table top, a counter, etc.). The rotatable surface is configured to rotate in a substantially horizontal plane relative to a bottom surface of the housing and the vertical track guides the rotatable surface when the rotatable surface moves in a direction perpendicular to the substantially horizontal plane. The 3D printing device further includes a scanning module (e.g., a camera, a laser, etc.) a printer head configured to deposit one or more layers of printing material on the rotatable surface, and a printer carriage configured to guide the printer head when the printer head deposits the one or more layers of printing material (e.g., on the rotatable surface). For example, the printer carriage guides the printer head along print axes that are substantially parallel to the substantially horizontal plane and perpendicular to the vertical direction. Preferably, the 3D printing device further includes a brake in communication with the rotatable surface. The brake is configured to prevent the rotatable surface from moving when the printer head deposits the one or more layers of printing material on the rotatable surface. Optionally, the 3D print apparatus includes a display screen (e.g., a touch screen) that displays options and receives user input (e.g., user commands) regarding a scan process, a copy process, and a print process.

With respect to the scanning module, the laser is configured to project light in a laser plane that intersects at least portions of the rotatable surface and an interior surface of the 3D printing device and the camera is configured to record a plurality of digital images including the laser plane intersecting the portions of the rotatable surface and the interior surface. The 3D printing device can further include at least one hardware processor adapted to execute one or more processes that translates portions of the plurality of digital images to a 3D coordinate system based on the laser plane intersecting the portions of the rotatable surface and the interior surface. Notably, the rotatable surface and the interior surface are typically associated with reference markings that facilitate the hardware processor translating portions of the plurality of digital images to the 3D coordinate system.

The hardware processor, when executing the one or more processes, also determines 3D coordinates for an object located on the rotating surface based, at least in part, on the intersection of the laser plane with each of the rotatable surface, the interior surface, and the object when the rotating surface is positioned at least two or more locations of the vertical track. When determining the 3D coordinates for the object, the processor further determines one or more bottom points of the 3D coordinates assigned to one or more bottom layers of the object located proximate the rotatable surface and replace the bottom points to create a flat bottom layer for the object (e.g., to provide a stable base for subsequent printing). Additionally, the one or more processes, when executed by the hardware processor, cause the processor to transmit the 3D coordinates for the object, using the one or more network interfaces, to a second 3D printing device causing the second 3D printing device to print the object.

In some embodiments, the one or more processes, when executed by the hardware processor, causes the 3D printing device to secure the rotatable surface having an object located thereon by engaging the brake. Notably, the rotatable surface at a first position on the vertical track and in a first rotation state. The one or more processes also cause the 3D printing device to release the brake from engaging the rotatable surface, rotate the rotatable surface to a second rotation state, and secure the rotatable surface having the object located thereon in the second rotation state by engaging the brake. The one or more processes further cause the 3D printing device to move the rotatable surface to a second position on the vertical track (e.g., with the rotatable surface in at least one of the first rotation state and the second rotation state), and scan the projected light of the laser in the laser plane. When scanning the projected laser light, the laser plane intersects with the object located on the rotatable surface, the interior surface of the 3D printing device, reference markings associated with each of the rotatable surface and the interior surface, and the rotatable surface at each of the first position, the second position, the first rotation state, the second rotation state. Object image data is recorded (e.g., by the camera) for a plurality of time intervals when the laser is scanning and a plurality of 3D coordinates for the object are determined based on the object image data, including the intersection of the laser plane.

According to another embodiment, a three dimensional (3D) printing device includes a hardware processor in communication with a camera and a laser, and a memory configured to store a 3D printing process executable by the hardware processor (e.g., 3D printing processes/techniques). The 3D printing device, (when employing the 3D printing techniques executed by the hardware processor) rotates a rotating surface according to a plurality of rotation states, moves the rotatable surface to two or more positions of a vertical track that is substantially perpendicular to a bottom surface of 3D printing device, and releasably engages a brake coupled to the rotating surface to releasably secure the rotating surface at each of the plurality of rotation states. The 3D printing device records initial image data (e.g., using the camera) for an area that includes the rotatable surface for each rotation state, the rotatable surface for each position of the vertical track, an interior surface of the 3D printing device, and reference markings associated with the rotatable surface and the interior surface. The 3D printing device assigns initial coordinates to portions of the reference markings of the initial image data in the 3D coordinate system.

The 3D printing device further scans a laser projecting light in a laser plane within a calibration area that includes the rotatable surface for each rotation state and position on the vertical track, and an interior surface of the 3D printing device, as well as reference markings associated with the rotatable surface and the interior surface. The 3D printing device records calibration image data for a plurality of time intervals when the laser scans the calibration area. The calibration image data includes, for example, calibration lines resulting from resulting from an intersection of the projected light in the laser plane and each of the rotatable surface and the interior surface, and the process is further operable to determine a plurality of 3D calibration coordinates in a 3D coordinate system for the calibration lines based on the reference markings (and the initial coordinates assigned to the portions of the reference markings).

The 3D printing device also scans the laser in an object area that includes an object located on the rotatable surface, the rotatable surface for each rotation state, the rotatable surface for each position of the vertical track, the interior surface of the 3D printing device, and the reference markings associated with the rotatable surface and the interior surface. Object image data is recorded for a plurality of time intervals and includes, for example, obstruction lines and object surface lines resulting from an intersection of the projected light in the laser plane with the rotatable surface, the interior surface, and the object.

The 3D printing device determines a plurality of 3D object coordinates for the object in the 3D coordinate system based on deviations between calibration image data and the object image data. For example, the 3D printing device determines the 3D object coordinates based on deviations between the calibration lines of the image data and each of the obstructed lines and object surface lines of the object image data.

In certain embodiments, the 3D printing device generates a point cloud that groups each 3D object coordinate for the object together, and connects each 3D object coordinate using a mesh to form printable 3D object data. This printable 3D object data can be faxed to a second 3D printing device (e.g., transmit the printable 3D object using network interfaces over a communication network to a second 3D printing device and causing the second 3D printing device to print a 3D object from the printable 3D object data).

In other embodiments, the 3D printing device determines a plurality of points of the 3D object coordinates assigned to one or more bottom layers for the object proximate to a printing surface, and replaces such points of the 3D object coordinates to create a flat bottom layer for the object proximate to the printing surface.

In certain other embodiments, when the 3D printing device determines the plurality of 3D calibration coordinates in the 3D coordinate system, the 3D printing device associates a first calibration line resulting from an intersection of the projected light in the laser plane and the rotatable surface with a second calibration line resulting from the intersection of the projected light in the laser plane and the interior surface for each time interval, and also determines paired calibration index points for each of the first calibration line and the second calibration line. The 3D printing device further assigns one coordinate from one of the paired calibration index points as a primary reference coordinate, and stores the paired calibration index points for the corresponding associated calibration lines according to the primary reference coordinate. According to these certain other embodiments, when the 3D printing device determines the plurality of 3D object coordinates, the 3D printing device further determines a 3D coordinate along one of the obstructed lines corresponding to a primary reference coordinate for each time interval, interpolates the paired calibration index points assigned to the primary reference coordinate to yield calibration lines, and determines the plurality of 3D object coordinates for the object in the 3D coordinate system based on deviations between points along the interpolated calibration lines and points along each of the obstructed lines and the object surface lines.

Additionally, when the 3D printing device determines the plurality of 3D object coordinates for the object, the 3D printing device further determines points of deviation between points along the interpolated calibration lines and points along each of the obstructed lines and the object surface lines, and assigns each point of deviation to the object. For each point of deviation, 3D printing device determines a projection line (e.g., an optical center line equation) that describes the line that goes through the optical center of the camera (e.g., a camera origin) to the respective point of deviation assigned to the object. The 3D printing device determines the plurality of 3D object coordinates based on an intersection of the optical center line and the laser plane.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates a perspective view of an exemplary three-dimensional (3D) printing device/apparatus according to one embodiment of this disclosure;

FIG. 2 illustrates an exploded perspective view of the 3D printing device shown in FIG. 1;

FIG. 3 illustrates a perspective view of a scanning module component of the 3D printing device shown in FIG. 1;

FIG. 4 illustrates a perspective view of a rotatable surface component of the 3D printing device shown in FIG. 1;

FIG. 5 illustrates a perspective view of a printing module of the 3D printing device shown in FIG. 1;

FIG. 6 is a schematic block diagram of the 3D printing device of in FIG. 1, showing one or more hardware and software components;

FIG. 7 illustrates a perspective view of an initial calibration process, translating a two dimensional (2D) image observed by a camera into a 3D coordinate system based on reference markings;

FIG. 8 illustrates a perspective view of the initial calibration process, showing obstruction of a laser plane by a rotatable surface and an interior surface of the 3D printing device resulting in a laser line;

FIG. 9 illustrates a perspective view of a scanning process, showing obstruction of a laser plane by an object;

FIG. 10 illustrates a perspective view of the scanning process, showing points along a surface line of the object and subsequent conversion of the points into the 3D coordinate system; and

FIG. 11 illustrates an example simplified procedure for calibrating, printing, scanning, copying, and faxing data for 3D objects, particularly from the perspective of the 3D printing device.

### DESCRIPTION OF EXAMPLE EMBODIMENTS

A three dimensional (3D) printing device or apparatus as disclosed herein, includes a housing, a rotatable surface contained within the housing, and a vertical track in communication with the rotatable surface. The rotatable surface configured to rotate in a substantially horizontal plane relative to a bottom surface of the housing, and the vertical track guides the rotatable surface when the rotatable surface moves in a direction perpendicular to the substantially horizontal plane. The 3D printing device further includes a scanning module (e.g., a camera, laser, etc.), a printer head configured to deposit one or more layers of printing material on the rotatable surface, and a printer carriage configured to guide the printer head when the printer head deposits the one or more layers of printing material.

As discussed herein, three dimension (3D) printing technologies include creating a 3D object (e.g., via layer deposition of a material, etc.), scanning the 3D object (e.g., observing an existing object and generating 3D descriptive data), copying, including scanning technology and printing technology, and faxing technology, including scanning an object and transmitting data over a network to another 3D printer causing it to print a 3D copy. Preferably, exemplary dimensions of a consumer model of the 3D copy machine and systems disclosed herein are intended to be “table-top” sized, it is appreciated that the embodiments and techniques discussed herein may also apply to larger-scaled 3D copy machines.

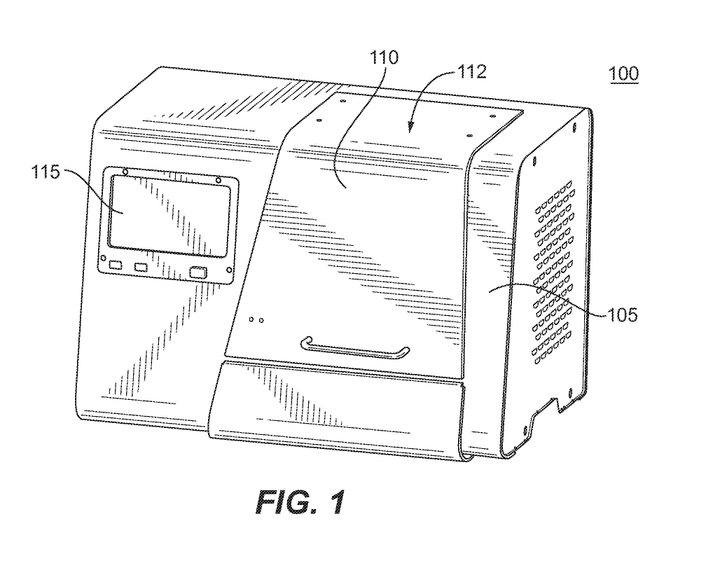

Referring now to the figures, FIG. 1 particularly illustrates a perspective view of an exemplary three-dimensional (3D) printing device/apparatus according to one embodiment of this disclosure. As shown, the 3D printing device includes a housing 105, a hinged door 110 that provides access to a printing/scanning area 112 and a display 115, which operates as a control (e.g., touch screen). In operation, to scan and/or copy an object, a user opens the hinged door 110 and places an object in the printing/scanning area 112. The user closes the hinged door and selects a corresponding command from display 115 to begin the scanning and/or copying process. The user can also select a print command and, provided there is enough space in the printing area, the 3D printing device 100 will begin depositing layers of printing material to create the object.

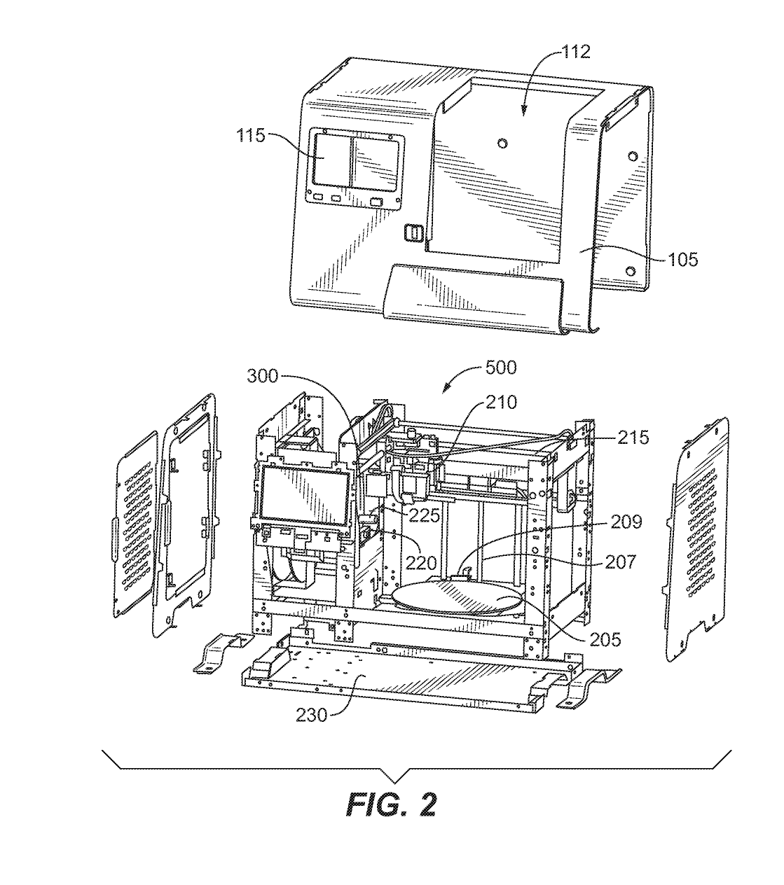

FIG. 2 illustrates an exploded perspective view of the 3D printing device shown in FIG. 1. As shown, the 3D printing device 100 includes a rotatable surface 205 (e.g., a turntable) guided along a vertical track 207, a printing module 500 that includes a printer head 210 guided by a printer carriage 215, and a scan module 300 that includes a digital camera 220 and a laser 225. A brake 209 is coupled to rotatable surface 205 and releasably engages or prevents rotatable surface 205 from moving when the 3D printing device is printing, copying and/or scanning and object. Operationally, the printer head 210 moves along printer carriage 215 and deposits printing material on the printing surface—here rotatable surface 205. Additionally, rotatable surface 205 is movable along a vertical track 207, which is particularly advantageous when scanning or copying an object. For example, as illustrated, scan module 300 is fixed in place relative to housing 105. However, rotatable surface 205 is movable in a vertical axis, relative to a bottom surface 230 of housing 105 (and relative to scan module 300). Scanning or copying an object from different vertical heights reduces and/or eliminates certain object occlusions that may occur when scanning from a single vantage relative to the object. For example, a figurine having a hat with a brim may occlude or otherwise obstruct a laser scan from a single vantage, which can result in discrepancies between a copied 3D version and the original. Scanning from different vantages (e.g., vertical heights) resolves such discrepancies.

With respect to the printing process, 3D printing device 100 typically processes a printable mesh for an object and slices the printable mesh into segments for printing. As discussed above, brake 209 engages the rotatable surface 205 when the printer head 210 deposits one or more layers of printing material. Preferably, the printing process also performs an auto bed-leveling procedure to estimate the plane of the rotatable surface 205.

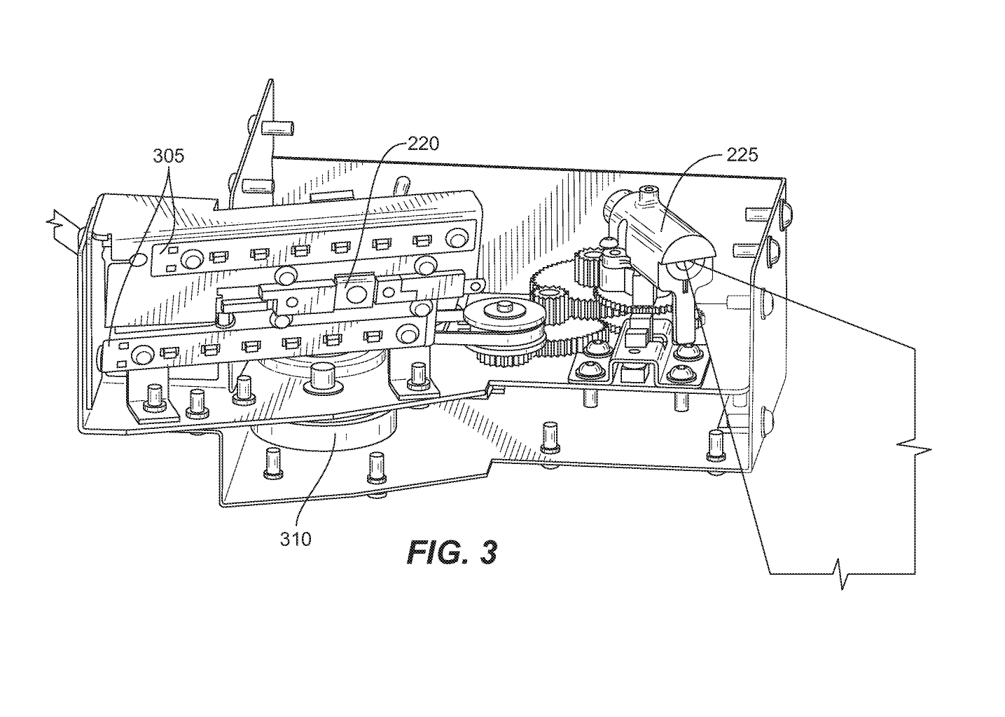

FIG. 3 illustrates a perspective view of scan module 300 of the 3D printing device 100. As discussed above, scan module 300 includes a digital camera 220 and a laser 225. As shown in FIG. 3, scan module 300 further includes one or more light emitting diodes (LEDs) 305, and a laser motor 310. Operationally, LEDs 305, digital camera 220, laser 225, and laser motor 310 cooperate to scan and/or copy an object placed on rotatable surface 205. For example, laser 225 is configured to project light in a laser plane and scan the printing area, including the rotatable surface 205, any object placed thereon, and portions of an interior surface of the 3D printing device 100. The laser plane moves or sweeps across the printing area as the laser motor 310 turns the laser 225. As discussed in greater detail below, intersection of the laser plane on the rotatable surface, objects placed thereon, and the portions of the interior surface result in a laser line, which provides an important reference when determining 3D coordinates for the object.

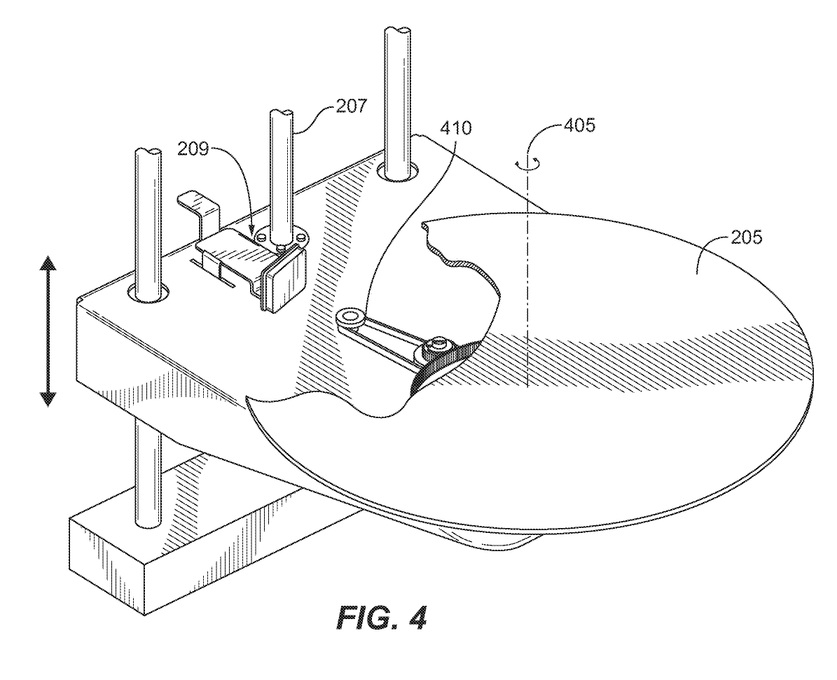

FIG. 4 illustrates a perspective view of the rotatable printing surface 205. As discussed above, rotatable surface 205 is movable along vertical track 207 advantageously allowing an object to be scanned at multiple vantages relative to scanning module 300. Additionally, rotatable surface 205 is configured to rotate about a turning axis 405 by, for example, a motor 410. Rotating the rotatable surface 205 importantly provides a larger printing surface without increasing the footprint of housing 105. Moreover, rotating the rotatable surface 205 allows an object to be scanned and printed without removing the object (e.g., the object is rotated out of the path of printer head 210 after scanning is complete).

Although certain 3D scanners use a rotating surface, 3D printers traditionally do not. One particular concern when 3D printing is precision required when depositing layers of material and unwanted movement of the printing surface. 3D printers typically require stable and non-movable printing surfaces since unwanted movement results in significant errors in printing (e.g., layers are not properly aligned/deposited). In order to realize the advantages of an increased printing area using a rotatable surface, the 3D printer disclosed herein provides the brake 209, that releasably engages or secures the printing surface to prevent rotation when printing an object while disengages or releases the printing surface to facilitate rotation when scanning the object.

The rotating surface 205 also supports Near-field scanning through Multi-Section Scanning. Multi-Section Scanning uses the Z-Axis (up and down) and rotating motion of the 3D Printer printing bed (e.g., rotation about the turning axis 405) to move the turntable in different positions.

Additionally, most 3D printers use XYZ carriage designs to guide printer heads, which only allows printing in a rectangular area. Here, however, rotatable surface 205 provides an additional axis or movement (e.g., rotating the turntable), which increases the printing area footprint for the printer head. Moreover, using a rotating printing surface 205, the 3D printing techniques disclosed herein can print multiple objects on the turntable. Once an object is printed, the embodiments herein may rotate it outside of the small XYZ printing area and continue printing in the cleared XYZ printing area.

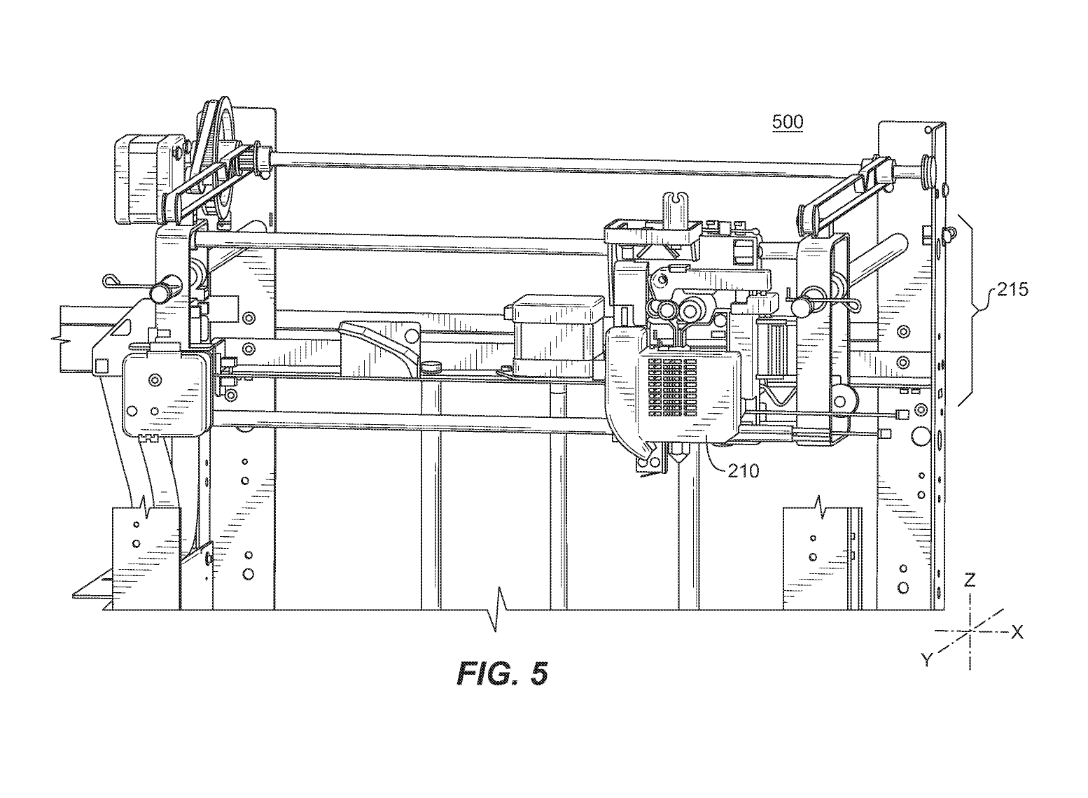

FIG. 5 illustrates a perspective view of the printing module 500. As discussed above, printer head 210 deposits one or more layers of printing material on the printing surface—here—rotating surface 205. Printer carriage 215 provides a path or track that guides printer head 210 when it deposits the one or more layers of printing material. As shown, printing head 210 and printer carriage 215 cooperate to provide three dimensions of movement for printer head 205—labeled as shown: “X”, “Y”, and “Z” directions.

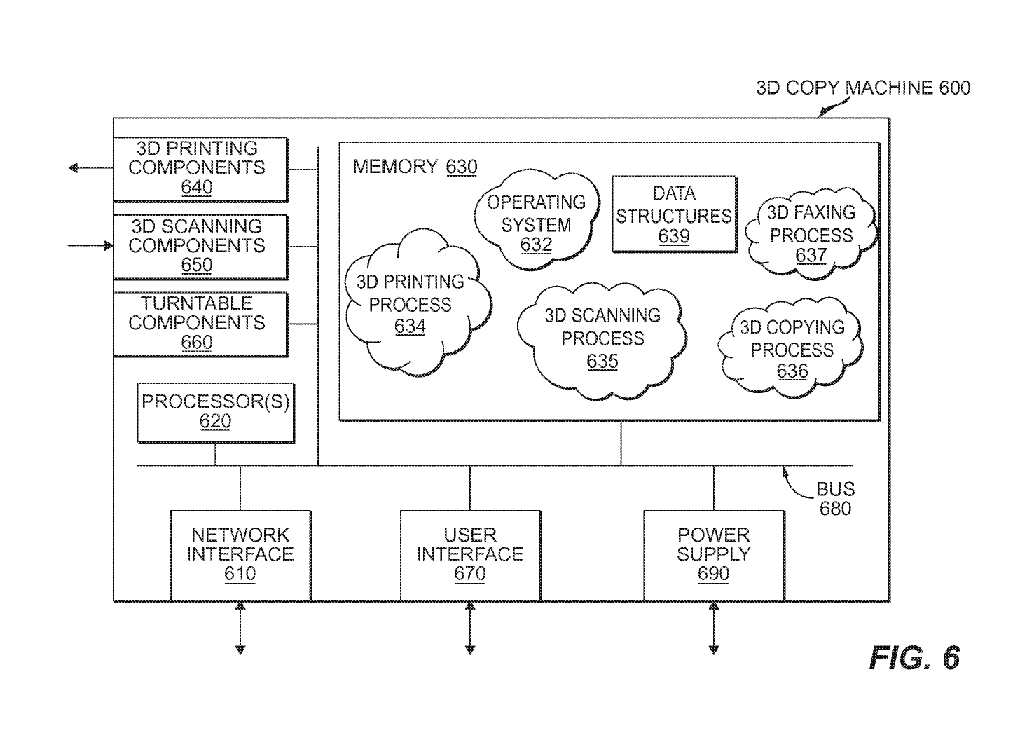

FIG. 6 is a schematic block diagram of the 3D printing device 100, showing one or more hardware and software components. Typically, the hardware or software components are co-located within a control module within housing 105, however, they may also include distributed modules (e.g., distributed processors, memory, etc.). As shown in FIG. 6, the 3D printing device may comprise a network interface 610, at least one processor 620, a memory 630, printing components 640, scanning components 650, turntable components 660, and user-interface components 670 interconnected by a system bus 680, as well as a power supply 690. Other components may be added to the embodiments herein, and the components listed herein are merely illustrative.

The network interface(s) 610 contain the mechanical, electrical, and signaling circuitry for communicating data over links coupled to a computer network. The memory 630 comprises a plurality of storage locations that are addressable by the processor 620 for storing software programs and data structures associated with the embodiments described herein. The processor 620 may comprise hardware elements or hardware logic adapted to execute the software programs and manipulate the data structures 639. An operating system 632, portions of which are typically resident in memory 630 and executed by the processor, functionally organizes the machine by, inter alia, invoking operations in support of software processes and/or services executing on the machine. These software processes and/or services may comprise 3D printing process 634, 3D scanning process 635, 3D copying process 636, and 3D faxing process 637, as described herein. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Furthermore, 3D printing components 640, 3D scanning components 650, and turntable components 660 contain the mechanical, electrical, and signaling circuitry for performing corresponding functions under the direction of the associated processes. For instance, 3D printing components 640 may comprise print heads, material storage, calibration components, etc. 3D scanning components 660 may comprise various cameras, lenses, lasers, light sources, reference guides, etc. Turntable components 670 may comprise a turntable, a motor, control circuitry, calibration technology, etc.

Illustratively, certain aspects of the techniques described herein may be performed by hardware, software, and/or firmware, such as in accordance with the various processes and components described above, which may contain computer executable instructions executed by the processor 620 and/or associated hardware components to perform functions relating to the techniques described herein.

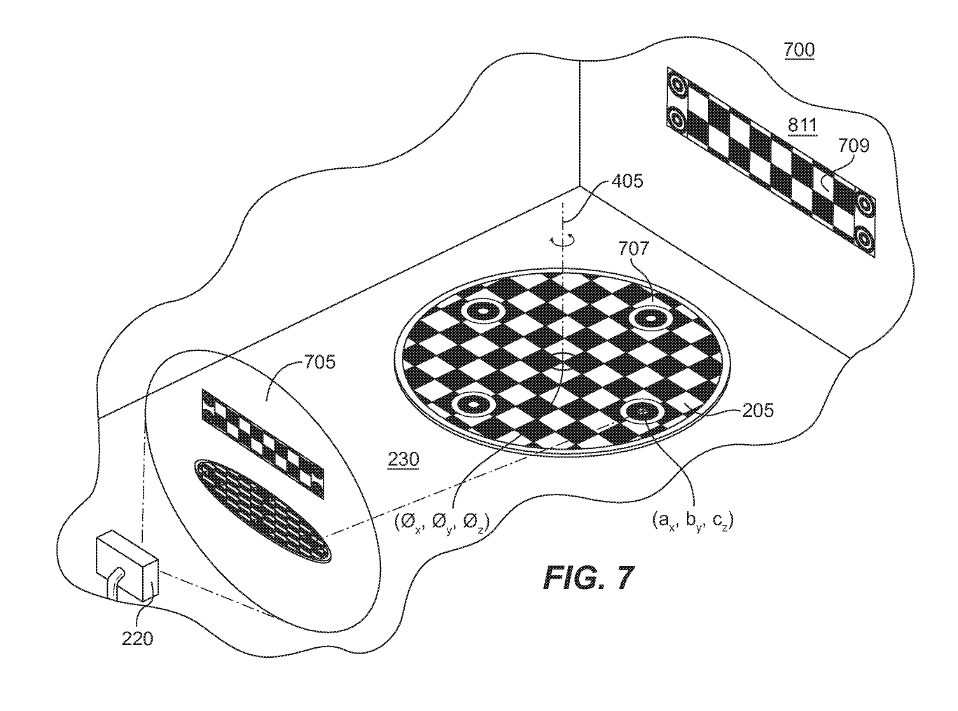

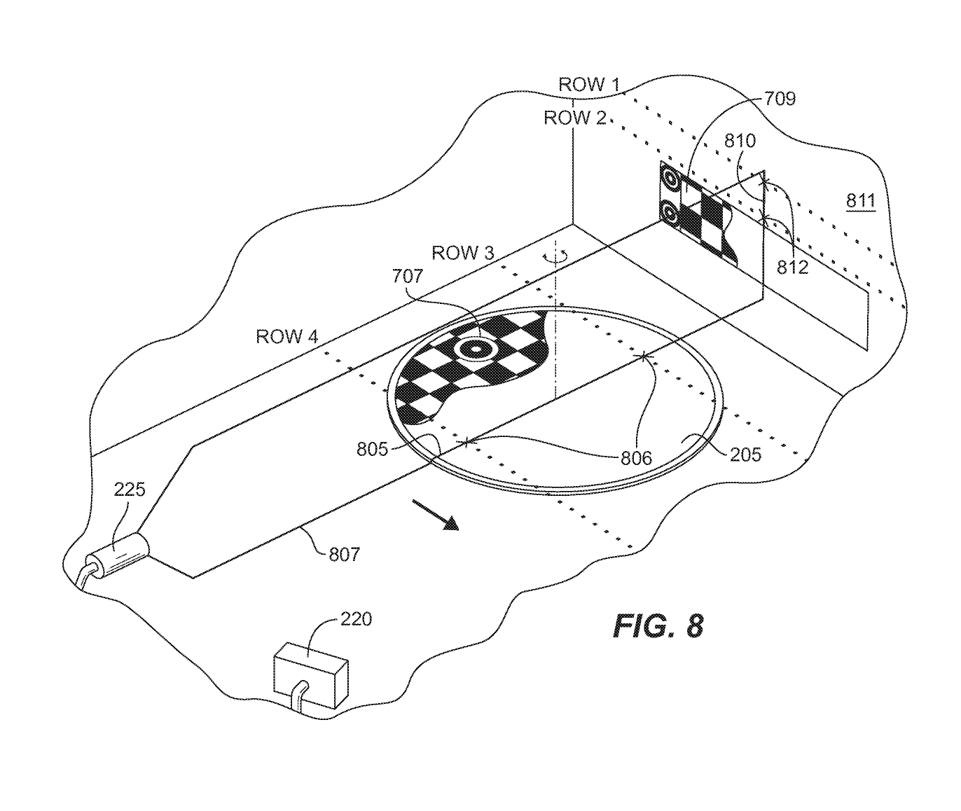

FIGS. 7-8 collectively illustrate portions of an initial calibration process, which establishes a 3D coordinate system used in printing, scanning, and copying. In particular, FIG. 7 illustrates a perspective view 700 of a two dimensional (2D) image 705 observed by camera 220, which is translated into the 3D coordinate system (aₓ, b_{y}, c_{z}) based on one or more reference markings.

According to the calibration process, 2D image data is translated into the 3D coordinate system. Typically, the calibration process is performed when the 3D printing device 100 is moved to any new location to account for non-level resting surfaces and/or after any disturbance to the resting surface of the machine (e.g., earthquake, etc.).

Calibration Process:

The calibration generally includes three stages. The first stage is mapping points of the 2D camera image 705 (e.g., points in a camera plane) to the rotatable surface 205 (e.g., points in the rotatable surface plane). According to this first stage, reference markings 707 (e.g., checkerboard pattern, etc.) are overlaid on the surface of the rotatable surface 205. Camera 220 takes an initial digital image 705 and a calibration process detects and maps the reference markings 707 of the image data to a 3D coordinate system. That is, coordinates for specific portions of the reference markings (e.g., a circle, a bullseye, etc.) are pinpointed to establish index points or boundaries by which other reference points are mapped. Image coordinates for portions of the 2D image are assigned to corresponding real world known 3D locations there are interpolated from the 3D coordinates of the reference markings 707. Notably, the reference markings 707 are shown as a checkerboard having specific circles or “targets” disposed therein. However, it is appreciated that markings 707 can be achieved using various types of patterns, inks, etchings, and the like, as is appreciate by those skilled in the art.

Generally, a specific pattern is incorporated on the rotatable surface 205 (e.g., inlaid, overlaid, embedded, etc.) that supports automated detection and recognition (e.g., shape recognition, line recognition, color change recognition, etc.). 3D coordinates are measured and recorded for various portions of the rotatable surface 205, including portions of the specific pattern. Preferably, the 3D coordinates are measured from an origin—position 0ₓ, 0_{y}, 0_{z}—which, as shown, marks a center of rotatable surface 205. In operation, camera 220 records an initial image 705 of rotatable surface 205. The initial image 705 includes image data that includes the rotatable surface 205 (without any objects disposed thereon) and reference markings 707. The calibration process detects the pattern or reference markings 707 in the image data (e.g., based on combinations of activated/deactivated pixels, shape recognition, discontinuity recognition, etc.). The calibration process further maps pixels of the camera 220 to a real-world 3D coordinate. In this fashion, points in the 2D camera image plane are mapped to a 3D coordinate that corresponds to points on rotatable surface 205. Additionally, the initial image data includes data corresponding to rotatable surface 205 positioned at various distances relative to the bottom surface 230 of the 3D printing device (e.g., different vertical heights along the vertical track 207), and rotatable surface 205 at various rotation states (e.g., degrees of rotation) about the rotation axis 405 (shown as coincident with a Z axis of the 3D coordinate system). Importantly, portions of the initial image data for each of these positions and/or states is mapped to corresponding mapping parameters in the 3D coordinate system and are used to establish positions of an object when the object is scanned at one or more of these positions and/or states. Additionally, the mapping parameters account for variances in the rotatable surface 205 plane. For example, in a perfect world, the rotatable surface 205 rotates about the rotating axis 405 in a perfectly planar fashion. However, real-world manufacturing discrepancies, non-level resting surfaces, and the like, can induce a wobble or an imperfect rotation when the rotating surface 205 rotates about rotating axis 405. The calibration process maps image data for the rotatable surface 205 for corresponding positions/states to account for such defects or discrepancies.

The second stage of calibration maps pixels of the image data for the interior surface 811 and corresponding reference markings 709 determines 3D coordinates for interior surface markings 709. As shown, reference markings 709 serve as a back plane to the rotatable surface 205 relative to camera 220. The same calibration process discussed above with respect to mapping points or pixels of 2D image data to the 3D coordinate system for the rotatable surface 205 is used to map portions of the image data for the interior surface 811 including reference markings 709.

The third stage of calibration includes mapping intersections of the laser plane with the rotatable surface 205 and the interior surface of housing 105 of the 3D printing device. In particular, FIG. 8 illustrates a perspective view of this third stage of the calibration process.

FIG. 8 illustrates laser 225 projecting light in a laser plane 807 and a resultant laser line—here, calibration lines 805 and 810—formed by the intersection between laser light in laser plane 807, the rotatable surface 205 and the interior surface 811. Calibration lines 805 and 807 are processed to determine calibration index points 806 and 812 (e.g., paired index points for a line equation), respectively. The calibration index points 806 and 812 serve as a basis for line equations (interpolated from index points 806 and 812) for a laser scan of an empty rotatable surface 205 (e.g., with no object disposed thereon). As discussed in greater detail below, the calibration lines are subsequently compared to object laser lines or obstruction lines formed when an object obstructs the calibration lines. Based (in part) on this comparison, 3D coordinates are determined for the object.

As shown, in FIG. 8, there are two calibration lines 805 and 807 that occur at a given instant during a laser scan. Indeed, during a laser scan, multiple images are recorded at specified time intervals by camera 220 when laser 225 scans across the rotatable surface 205 and across the interior surface 811 creating many calibration lines (for each image). For example, upwards of 400 images may be recorded for a single laser scan. Additionally, the calibration lines are recorded for rotatable surface 205 positioned at various vertical distances along vertical track 207 and for various states of rotation. For each image, paired calibration index points for a corresponding calibration line are recorded and stored. These paired calibration index points are recorded at particular locations (e.g., rows 1-4) for the rotatable surface 205 and the interior surface 811.

Generally, the calibration index points are taken close to opposite ends of laser lines that fall on the rotatable surface 205 and interior surface 811, respectively. For example, the calibration process records calibration index points for each calibration line (for each image) in four different rows in the image one pair corresponding to points in row 1 and row 2 and one pair corresponding to points in row 3 and row 4. As shown, row 1 is located proximate to the top of the line on the interior surface 811, while row 2 is located proximate to the bottom of the line on the interior surface 811, row 3 is located near a far end of the rotatable surface 205 (relative to the camera 220), and row 4 is located near a close end of the rotatable surface 205 (relative to the camera 220). The calibration process stores the paired calibration index points for the calibration line, which are later used to yield a line equation for the corresponding calibration line. In this fashion, the calibration process efficiently stores a smaller amount of data rather than storing numerous points along each calibration line.

In certain embodiments, when scanning an object, sometimes only the top calibration index point of the interior surface 811 is shown since the object may obstruct the remaining reference points. For example, the object can occlude large portions of surface 205 as well as a lower portion of the interior surface 811. Accordingly, for these embodiments, the calibration process preferably stores the paired calibration index points for intersections of light of the laser plane 807 according to the primary reference coordinate (e.g., using the primary reference coordinate as an index or lookup for the remaining calibration index points). That is, once the primary reference coordinate is identified, the remaining calibration index points are retrieved and corresponding line equations are utilized.

Additionally, in an effort to smooth out laser recognition error (as well as because the calibration laser swipe does not record every column coordinate on the top background laser location), the calibration process interpolates a coordinate column locations for all four designated rows. As a result, the calibration process only stores two coefficients for each line, eight coefficients altogether.

Collectively, FIGS. 7-8 illustrate the initial calibration process where 2D image data (FIG. 7) is mapped to a real-world 3D coordinate system and initial calibration lines (FIG. 8) are determined for a laser scan of a scanning/copying/printing area (e.g., including the rotatable surface 205, and the interior surface 811). Generally, to determine the various calibration lines, laser light scans over the empty rotatable surface 205 and images are recorded at various time intervals. For each image, four intersection points are extracted to serve as reference points for an interpolated calibration line—two intersection points are used to determine calibration lines along the interior surface plane and two intersection points are used to determine calibration lines along the rotatable surface 205. All calculated intersection points are recorded (four for each image, many (e.g., 400) images per laser swipe) and interpolated. As a result, the calibration process herein obtains four interpolation lines. Each line consists of two line coefficients, thus there are eight coefficients, which are then stored. During scanning, the background laser line and the turntable laser line can be reconstructed by one guidance point plus the eight coefficients.

3D Scan & 3D Copy Techniques

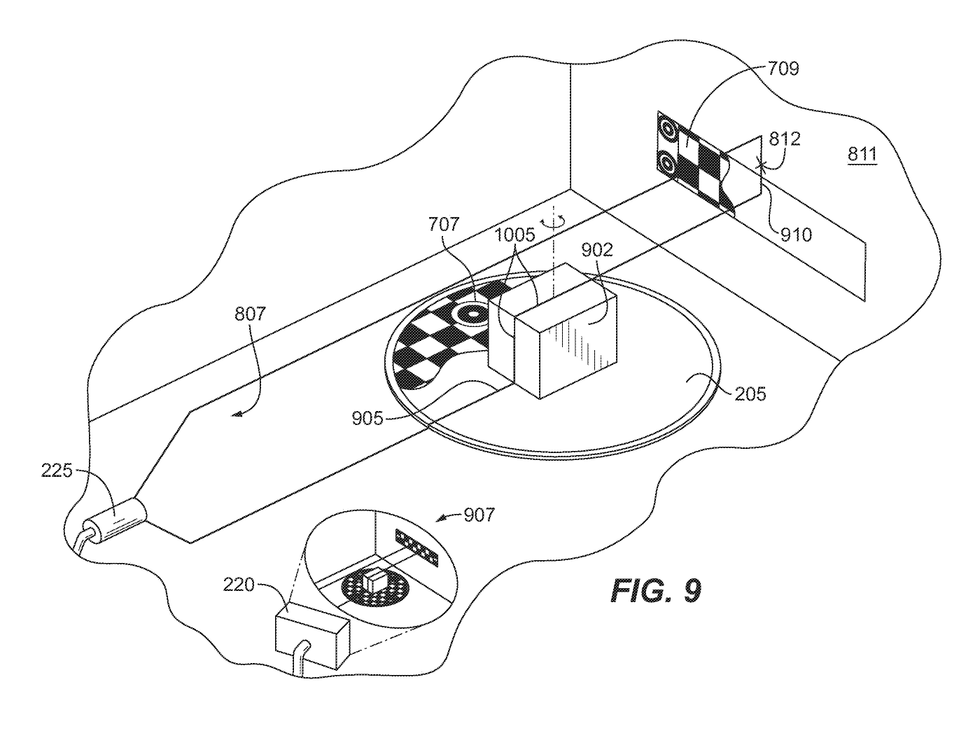

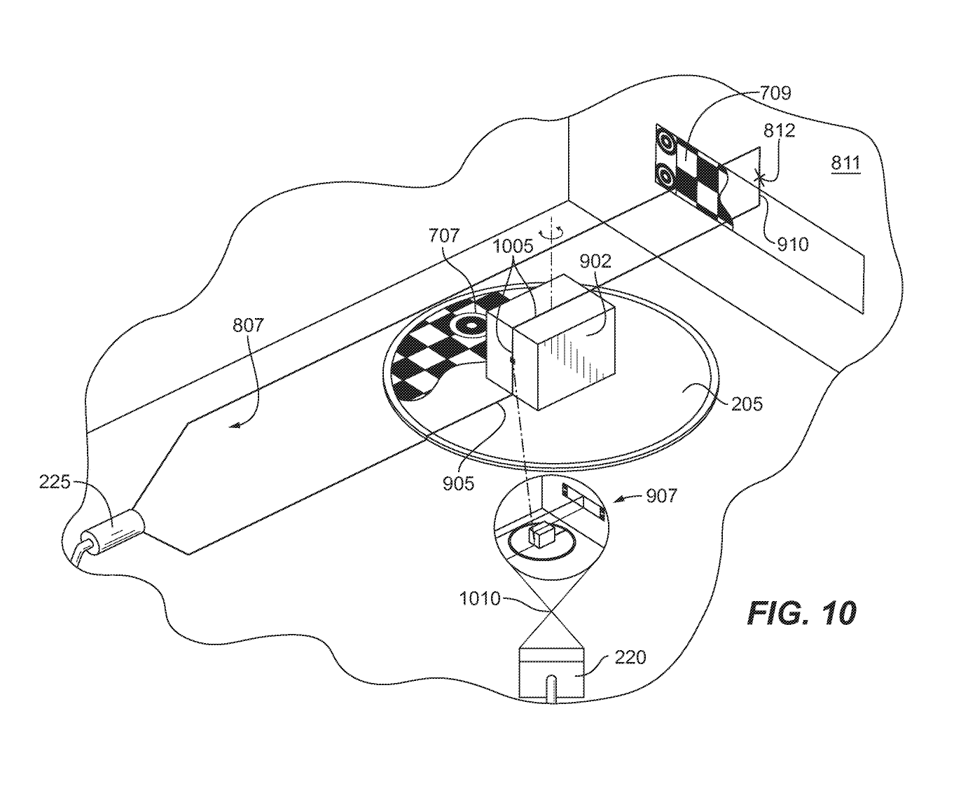

Collectively, FIGS. 9-10 illustrate perspective views of portions of the scanning and/or copying process (e.g., in accordance with scanning process 635 and/or 3D copying process 636). The perspective views shown in FIGS. 9-10 are for purposes of illustration, not limitation. The perspective views shown in FIGS. 9-10 particularly show laser light projected by laser 225 in laser plane 807 intersecting the rotatable surface 205, the interior surface 811, and an object 902, and is viewed from the perspective of an image recorded by camera 220 for a specified interval. It is appreciated that, during the scanning process, laser light is projected by laser 225 and is scanned across the scanning area while camera 220 records image data at specified intervals.

Referring to FIG. 9, light of laser plane 807 intersects the rotatable surface 205 and the interior surface 811 resulting in laser lines. For an empty rotatable surface 205, such laser lines are referred to as calibration lines (ref. FIG. 8, above). For a rotatable surface 205 having an object disposed thereon, the laser lines are referred to as obstructed lines. As shown in FIG. 9, two obstructed lines —905 and 910—resulting from an intersection of laser plane 807 and rotatable surface 905, as partially obstructed by object 902, and an intersection of laser plane 807 and the interior surface 811, as partially obstructed by object 902. Notably, when light projected by laser 225 in laser plane 807 intersects or is obstructed by object 902, a surface line 1005 is also formed along the surface of object 902.

According to the scanning process, points along the intersection lines of laser plane 807 (including points along surface line 1005) for each image are grouped or assigned to one of the rotatable surface 205, the object 902, and the interior surface 811. For example, the scanning process determines corresponding calibration lines for each recorded image from the primary reference coordinate, as discussed above. The points along the obstruction lines 905 and 910 and points along the surface line 1005 are compared to calibration lines to determine points of deviation. Points that correspond to one of the calibration lines are assigned to one of the rotatable surface 205 or the interior surface 811 (e.g., depending on which calibration line the respective points fall within), while the points of deviation are assigned to object 902. In some embodiments, points that are very close (e.g., within a few pixels) to a calibration line along the interior surface 811 are considered to belong to the interior surface 811. This process is repeated for each image using corresponding calibration lines (e.g., for images taken at the specified intervals and for the various rotation states and positions of rotatable surface 205 with object 902 located on the rotatable surface 205). The resultant object points are further processed to determine corresponding 3D coordinates, as shown in FIG. 10 and discussed below.

Referring now to FIG. 10, a perspective view of the scanning process shows points (e.g., object points discussed above) along the surface line 1005 of object 902 and subsequent conversion of these points into the 3D coordinate system. According to the scanning process, a laser plane equation for laser plane 807 is determined for each recorded image. The laser plane equation is determined, in part, by the calibration lines used to assign the points to the rotatable surface 205, the interior surface 811, and the object 902. The points assigned to the rotatable surface 205 and interior surface 811 are then separately interpolated to produce two line equations. These two lines are then fit (e.g., using a least squares fit method, etc.) to yield a laser plane. Note that these interpolated lines can also be replaced by the reference calibration lines 805 on the turntable and 810 on the interior surface; however the interpolated lines yield a more accurate 3D coordinate results. The scanning process also determines a projection line equation from each object point to the optical or camera center point (e.g., a single reference point) for camera 220. The scanning process determines a 3D coordinate for each object point by an intersection of the projection line and the laser plane. In this fashion, 2D pixels in the camera are mapped to the 3D coordinate system for each object point. The scanning process determines 3D coordinates for each object point in each image (e.g., for various rotation states/positions of rotatable surface 205). The 3D coordinates for each object point are preferably further fused together to form a point cloud for a single 3D object. Such point cloud can be stored locally, or it may be sent to distributed storage locations over a network (e.g., the Internet).

In some embodiments, the scanning process further generates a mesh or a surface for each point cloud, which connects the points to form a surface (e.g., typically including triangular shaped surface units). Additionally, post processing methods for filtering, smoothing, noise reduction, etc., may be used both on the point cloud or the mesh, as is appreciated by those skilled in the art.

In certain other embodiments, the scanning process further provides the 3D object with a stable base (e.g., for subsequent printing). That is, once a point cloud is established for a scanned object, the scanning process ensures that a base of the point cloud can solidly support the structure for subsequent printing purposes. This is done by replacing portions of the point cloud proximate to the rotatable surface 205 with a grid of point stable base points. To do this, the scanning process creates an object base boundary. The algorithm first estimates the center of the base. This is done by computing the center of mass for parts of the point cloud that are within the first few deposition layers of the object (e.g., points that are a short or small distance in a Z direction relative to the rotatable surface 205). For example, such lower deposition layers can include about 2 mm to 3 mm from the rotatable surface 205. The scanning process divides the same subset of point cloud points into sectors around the object to a reasonably fine resolution (e.g., 0.01 degree resolution). For every sector, the scanning process locates a point from the point cloud subset with the longest in XY distance (or rotatable surface distance) from the estimated center of the base of the object. Once these boundaries are selected, the scanning process fills the base in a regular grid manner.

Once the base is created, the scanning process generates a 3D surface mesh by appropriately connecting the points to create triangular sides throughout the surface of the object, as discussed above. For example, the scanning process can use Poisson reconstruction techniques. Once the mesh is generated, the scanning process can flatten out bottom portions of the mesh that may have ballooned out due to Poisson reconstruction.

3D Cloud Processing Techniques

The scanning and copying process (and faxing) can also use cloud resources (e.g., computing, memory, etc.). For example, in some embodiments, the 3D object is scanned, and laser lines are extracted from the 3D scanning data. These 2D laser lines, which may include hundreds of points, are locally stored in memory of the 3D printing device. These laser lines are further compressed and sent to cloud resources for additional processing. The laser lines are preferably locally stored in 2D to reduce memory usage and enable efficient and quick upload to the cloud resources.

In the cloud, parallel processors convert the 2D laser lines into 3D coordinates. For example, the compressed laser lines are un-compressed or unzipped and preferably processed by a separate cloud resource or cloud node. During the cloud processing, points of laser line are transformed from 2D (camera image) into 3D (line as point cloud), using techniques discussed above. The cloud resources further fuse all 3D coordinate points (e.g., point cloud for the 3D object) together to create a mesh for the scanned object. Additional post-processing is also preferably handled by cloud resources. Such post processing includes, for example, filtering, smoothing, providing a flat bottom, etc.

Once the 3D object is created, the cloud resources also perform slicing operations which form layers printed by a printer head. Optionally, the cloud resources can compress the 3D object data and send it to a printer for subsequent printing.

3D Simplified Procedures

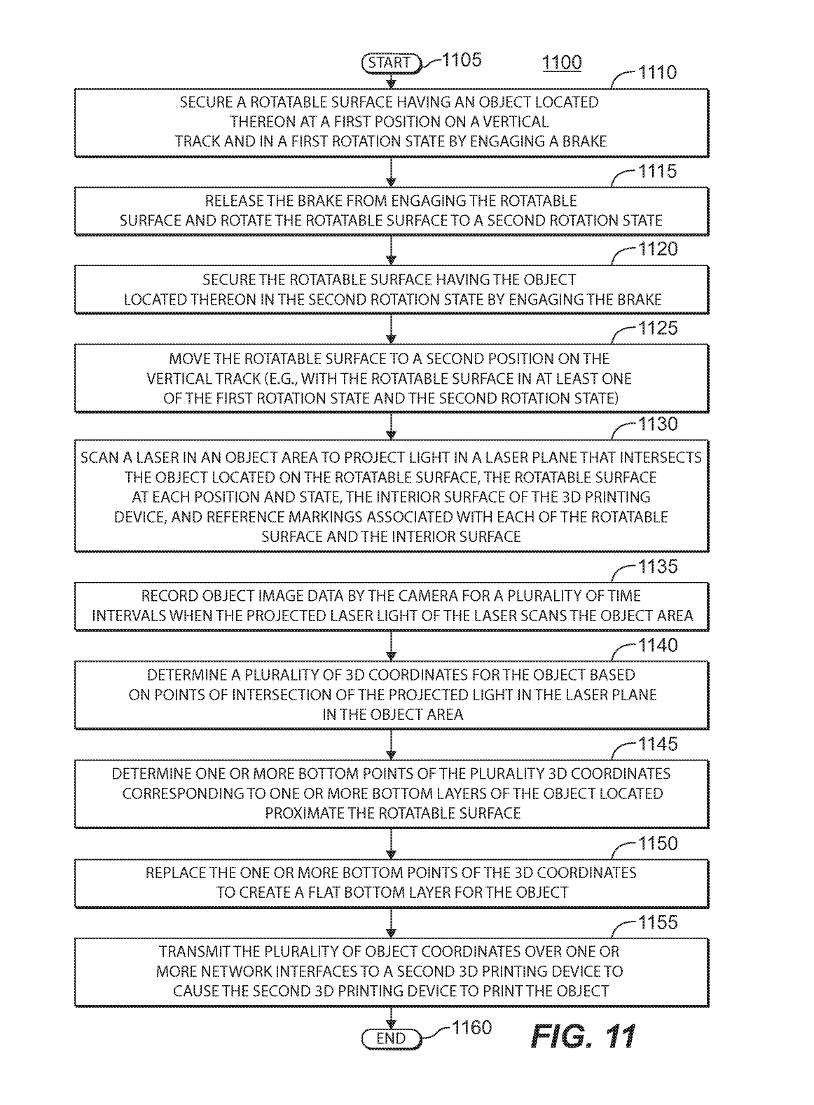

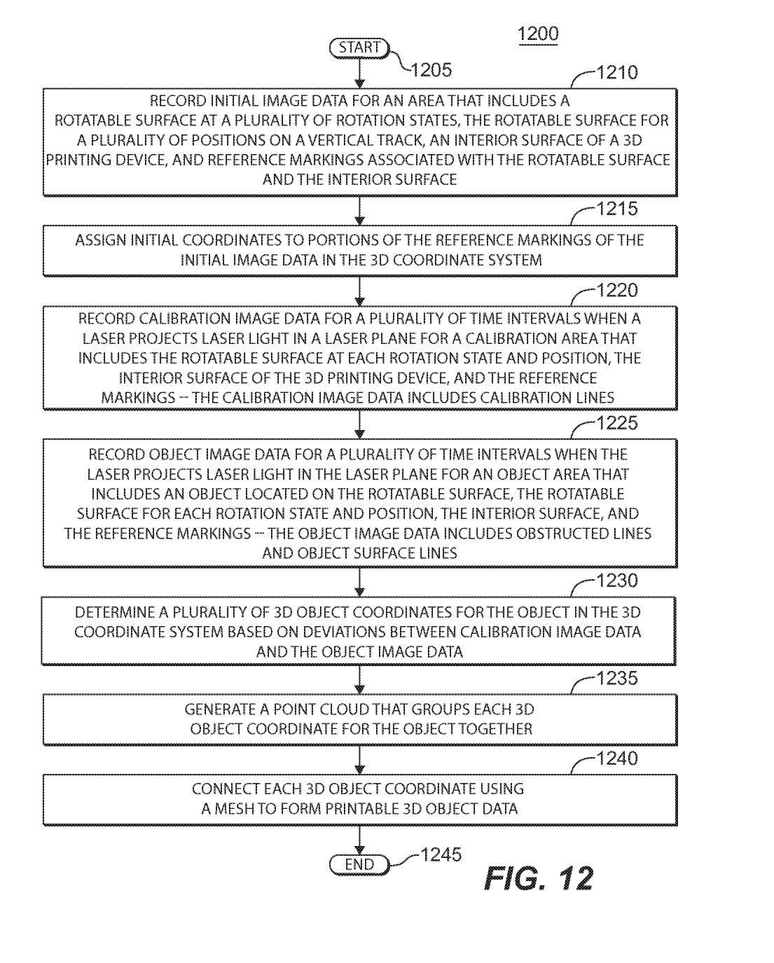

Referring now to FIGS. 11-12, exemplary simplified procedures are provided for calibrating, printing, scanning, and faxing data for 3D objects, particularly from the perspective of the 3D printing device.

FIG. 11 provides an exemplary simplified procedure 1100 which begins at step 1105 and continues to step 1110 where, as discussed above, a 3D printing device secures a rotatable surface having an object located thereon at a first position on the vertical track and in a first rotation state by engaging a brake. Steps 1115 to steps 1125 demonstrate the 3D printing device rotating the rotatable surface into multiple rotation states or degrees or rotation (step 1120), and for multiple positions along the vertical track (step 1130). The 3D printing device secures the rotatable surface for each rotation state and position by engaging the brake (step 1120).

The 3D printing device, in step 1130 scans a laser in an object area to project light in a laser plane that intersects the object located on the rotatable surface, the interior surface of the 3D printing device, the rotatable surface at each state and position. Object image data is recorded in step 1135, by the 3D printing device, for a plurality of time intervals when the projected laser light of the laser scans the object area. As discussed above, the 3D printing device rotates the rotatable surface to various rotation states to scan and record a laser line intersection for different sides of the object as well as different heights of the object (e.g., by moving the rotatable surface along the vertical track, etc.). Using these various laser line intersections (which are part of the recorded object image data) a plurality of 3D coordinates are determined for the object. Specifically, in step 1150, the 3D printing device determines a plurality of 3D coordinates for the object based on points of intersection of the projected light in the laser plane in the object area.

As discussed above, in certain embodiments, the 3D printing device determines (step 1145) one or more bottom points of the plurality 3D coordinates corresponding to one or more bottom layers of the object located proximate the rotatable surface and in step 1150, the 3D printing device replace the one or more bottom points of the 3D coordinates to create a flat bottom layer for the object. In this fashion, the 3D coordinates, when subsequently used to print an object, provide a stable base for depositing printing material.

Additionally, in other embodiments, the 3D printing device can fax the 3D object data (e.g., the plurality of object coordinates) over network interfaces to another 3D printing device to cause the 3D printing device to print an object based on the 3D object data, shown in step 1155.

Procedure 1100 subsequently ends in step 1160, but may begin again in step 1105 where the 3D printing device secures the rotatable surface by a brake (e.g., for a printing, scanning, or copying process, etc.).

FIG. 12 provides another exemplary simplified procedure 1200, also from the perspective of a 3D printing device. Procedure 1200 begins at step 1205 and continues to step 1210 where the 3D printing device records initial image data for an area that includes a rotatable surface at a plurality of rotation states, the rotatable surface for a plurality of positions on a vertical track, an interior surface of a 3D printing device, and reference markings associated with the rotatable surface and the interior surface. In step 1215, the 3D printing device assigns initial coordinates to portions of the reference markings of the initial image data in the 3D coordinate system, as discussed in greater detail above.

As discussed above, the 3D printing device records, in step 1220, calibration image data for a plurality of time intervals when a laser projects laser light in a laser plane for a calibration area. The calibration area includes the rotatable surface at each rotatable state and position, an interior surface of a 3D printing device, and the reference markings associated with the rotatable surface and the interior surface. Notably, the calibration image data includes calibration lines that result from an intersection of the laser plane with the rotatable surface, the interior surface, and the reference markings. Optionally, in certain embodiments, the 3D printing device can determine calibration coordinates in a 3D coordinate system for corresponding calibration lines (e.g., based on the initial coordinates assigned to portions of the reference markings, etc.).

The 3D printing device further records, in step 1225, object image data for a plurality of time intervals when the laser projects laser light in the laser plane for an object area. The object area differs from the calibration area in that the object area further includes an object located on the rotatable surface. The object image data also includes obstructed lines and object surface lines, as discussed above (e.g., resulting from an intersection of the projected light in the laser plane with the rotatable surface, the interior surface, and the object, etc.).

In step 1230, the 3D printing device further determines a plurality of 3D object coordinates based on deviations between calibration image data and the object image data. For example, such deviations can include points of deviation between calibration lines, obstructed lines, and object surface lines. Moreover, as discussed above, techniques to determine such deviations include determining a primary reference coordinate (e.g., a point along an obstructed line corresponding to the primary reference coordinate for calibration lines), interpolating calibration lines associated with the primary reference coordinate, and determining points of deviation between the calibration lines and points along each of the obstructed lines and the object surface lines. Such points of deviation are assigned to the object, which are later used to determine specific 3D coordinates for the object (e.g., using an intersection of its optical center line (measured from an optical center point or origin of the camera) and a laser plane determined from the calibration lines), discussed in greater detail above.

Once the plurality of 3D coordinates are determined for the object, the 3D printing device, in step 1235 generates a point cloud that groups each 3D object coordinate for the object together and, in step 1240, the 3D printing device connects each 3D object coordinate using a mesh to form printable 3D object data. Such printable object data can be compressed and “faxed” (transmitted) to subsequent 3D printing devices (e.g., using network interfaces) causing such subsequent devices to print an object based on the printable 3D object data. Procedure 1200 may subsequently end at step 1245, but may begin again at step 1205 where the 3D printing device records initial image data, as discussed above.

It should be noted that certain steps within procedures 1100-1200 may be optional, and the steps shown in FIGS. 11-12 are merely examples for illustration. Certain other steps may be included or excluded as desired. Further, while a particular order of the steps is shown, this ordering is merely illustrative, and any suitable arrangement of the steps may be utilized without departing from the scope of the embodiments herein. Moreover, while procedures 1100-1200 are described separately, certain steps from each procedure may be incorporated into each other procedure, and the procedures are not meant to be mutually exclusive.

The embodiments described herein, therefore, provide for a four-in-one 3D copy machine with various novel features. While there have been shown and described illustrative embodiments of the four-in-one 3D copy machine, it is to be understood that various other adaptations and modifications may be made within the spirit and scope of the embodiments herein. For example, the embodiments have been shown and described herein as an all-in-one device. However, certain inventive features of the embodiments herein in their broader sense are not as limited, and may, in fact, be used separately with corresponding components. For instance, turntable calibration, cloud data processing, circular turntable printing, etc., need not be limited to a four-in-one (all-in-one) device.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A three dimensional (3D) printing device, comprising:
a housing;
a rotatable surface contained within the housing, the rotatable surface configured to rotate in a substantially horizontal plane relative to a bottom surface of the housing;
a vertical track in communication with the rotatable surface that guides the rotatable surface when the rotatable surface moves in a direction perpendicular to the substantially horizontal plane;
a scanning module, including a camera and a laser;
a printer head configured to deposit one or more layers of printing material on the rotatable surface; and
a printer carriage configured to guide the printer head when the printer head deposits the one or more layers of printing material on the rotatable surface.

2. The 3D printing device of claim 1, wherein the printer carriage is further configured to guide the printer head along print axes that are substantially parallel to the substantially horizontal plane and perpendicular to the vertical direction.

3. The 3D printing device of claim 1, further comprising:
a display screen configured to display options and receive user input regarding a scan process, a copy process, and a print process.

4. The 3D printing device of claim 1, wherein the bottom surface of the housing has an area greater than a top surface of the housing to provide stability for the housing of the 3D printing device when placed on a surface.

5. The 3D printing device of claim 1, wherein the laser is configured to project light in a laser plane that intersects portions of the rotatable surface and an interior surface of the 3D printing device, wherein the camera is configured to record a plurality of images when the laser plane intersects the portions of the rotatable surface and the portions of the interior surface, the 3D printing device further comprising:
at least one hardware processor, and
a memory configured to store a process executable by the hardware processor, the process when executed operable to:
determine calibration coordinates for portions of the plurality of images in the 3D coordinate system based on calibration lines resulting from intersection of the laser plane and each of the portions of the rotatable surface and the portions of the interior surface.

6. The 3D printing device of claim 5, wherein the rotatable surface and the interior surface are associated with reference markings, wherein the process to determine the calibration coordinates for the portions of the plurality of images in the 3D coordinate system, when executed by the processor, is further operable to determine the calibration coordinates for the portions of the plurality of digital images in the 3D coordinate system based on the reference markings.

7. The 3D printing device of claim 1, further comprising:
a brake in communication with the rotatable surface configured to prevent the rotatable surface from rotating.

8. The 3D printing device of claim 7, further comprising:
at least one hardware processor, and
a memory configured to store a process executable by the hardware processor, the process when executed operable to:
secure the rotatable surface having an object located thereon by engaging the brake, the rotatable surface located at a first position on the vertical track and in a first rotation state;
release the brake from engaging the rotatable surface;
rotate the rotatable surface having the object located thereon to a second rotation state;
secure the rotatable surface having the object located thereon in the second rotation state by engaging the brake,
move the rotatable surface having the object located thereon to a second position on the vertical track, the rotatable surface in at least one of the first rotation state and the second rotation state;
scan the laser in an object area to project light in a laser plane that intersects the object located on the rotatable surface, the rotatable surface at each position, the rotatable surface at each rotation state, and the interior surface of the 3D printing device;
record object image data by the camera for a plurality of time intervals when the projected laser light of the laser scans in the object area; and
determine a plurality of 3D coordinates for the object based on points of intersection of the projected light in the laser plane in the object area.

9. The 3D printing device of claim 8, further comprising:
one or more network interfaces adapted to communicate in a communication network, and
wherein the process, when executed by the hardware processor, is operable to transmit the plurality of 3D coordinates for the object, using the one or more network interfaces, to a second 3D printing device causing the second 3D printing device to print the object.

10. The 3D printing device of claim 9, wherein the process, when executed by the hardware processor to determine the plurality of 3D coordinates for the object, is further operable to:
determine one or more bottom points of the plurality of 3D coordinates corresponding to one or more bottom layers of the object located proximate the rotatable surface; and
replace the one or more bottom points of the 3D coordinates to create a flat bottom layer for the object.

11. A three dimensional (3D) printing device, comprising:
a hardware processor in communication with a camera and a laser; and
a memory configured to store a process executable by the hardware processor, the process when executed operable to:
rotate a rotating surface according to a plurality of rotation states;
move the rotatable surface to two or more positions of a vertical track that is substantially perpendicular to a bottom surface of 3D printing device;
releasably engage a brake coupled to the rotating surface to releasably secure the rotating surface at each of the plurality of rotation states;
scan a laser projecting light in a laser plane in a calibration area that includes the rotatable surface for each rotation state, the rotatable surface for each position of the vertical track, an interior surface of the 3D printing device, and reference markings associated with the rotatable surface and the interior surface;
record calibration image data for a plurality of time intervals when the laser scans the calibration area, the calibration image data includes calibration lines resulting from an intersection of the projected light in the laser plane and each of the rotatable surface and the interior surface;
determine calibration coordinates in a 3D coordinate system for corresponding calibration lines based on the reference markings;
scan the laser projecting light in the laser plane in an object area that includes an object located on the rotatable surface, the rotatable surface for each rotation state, the rotatable surface for each position of the vertical track, and the interior surface of the 3D printing device;
record object image data for a plurality of time intervals when the laser scans the object area, the object image data includes obstructed lines and object surface lines resulting from an intersection of the projected light in the laser plane with the rotatable surface, the interior surface, and the object; and
determine a plurality of 3D object coordinates for the object in the 3D coordinate system based on deviations between calibration image data and the object image data.

12. The 3D printing device of claim 11, wherein the process to determine the plurality of 3D object coordinates for the object, when executed by the hardware processor, is further operable to:
determine the plurality of 3D object coordinates for the object in the 3D coordinate system based on deviations between the calibration lines of the image data and each of the obstructed lines and object surface lines of the object image data.

13. The 3D printing device of claim 11, wherein the process, when executed by the hardware processor, is further operable to:
generate a point cloud that groups each 3D object coordinate for the object together; and
connect each 3D object coordinate using a mesh to form printable 3D object data.

14. The 3D printing device of claim 13, further comprising:
one or more network interfaces adapted to communicate in a communication network, and
wherein the process, when executed by the hardware processor, is further operable to transmit the printable 3D object data to a second 3D printing device over the communication network using the network interfaces to cause the second 3D printing device to print a 3D object from the printable 3D object data.

15. The 3D printing device of claim 11, wherein the process, when executed by the hardware processor, is further operable to:
determine a plurality of points of the 3D object coordinates assigned to one or more bottom layers for the object proximate to a printing surface; and
replace the one or more of the plurality of points of the 3D object coordinates to create a flat bottom layer for the object proximate to the printing surface.

16. The 3D printing device of claim 11, wherein the process to determine the plurality of 3D calibration coordinates in the 3D coordinate system, when executed by the hardware processor, is further operable to:
associate a first calibration line resulting from an intersection of the projected light in the laser plane and the rotatable surface with a second calibration line resulting from the intersection of the projected light in the laser plane and the interior surface for each time interval;
determine paired calibration index points for each of the first calibration line and the second calibration line;
assign one coordinate from one of the paired calibration index points as a primary reference coordinate; and
store the paired calibration index points for the corresponding associated calibration lines according to the primary reference coordinate.

17. The 3D printing device of claim 16, wherein the process to determine the plurality of 3D object coordinates for the object, when executed by the hardware processor, is further operable to:
determine a 3D coordinate along one of the obstructed lines corresponding to a primary reference coordinate for each time interval;
interpolate the paired calibration index points assigned to the primary reference coordinate to yield calibration lines;
determine the plurality of 3D object coordinates for the object in the 3D coordinate system based on deviations between points along the interpolated calibration lines and points along each of the obstructed lines and the object surface lines.

18. The 3D printing device of claim 17, wherein the process to determine the plurality of 3D object coordinates for the object, when executed by the hardware processor, is further operable to:
determine points of deviation between points along the interpolated calibration lines and points along each of the obstructed lines and the object surface lines;
assign each point of deviation to the object;
determine, for each point of deviation assigned to the object, a deviation laser plane based on the calibration lines;
determine, for each point of deviation assigned to the object, a projection line that passes through an optical center point of the camera to each point of deviation assigned to the object; and
determine the plurality of 3D object coordinates for the object based on an intersection of the projection line and the deviation laser plane.

19. The 3D printing device of claim 11, wherein the process, when executed by the hardware processor, is further operable to:
record initial image data for an area that includes the rotatable surface for each rotation state, the rotatable surface for each position of the vertical track, an interior surface of the 3D printing device, an interior surface of the 3D printing device, and reference markings associated with the rotatable surface and the interior surface; and
assign initial coordinates to portions of the reference markings of the initial image data in the 3D coordinate system, and
wherein the process to determine the calibration coordinates in a 3D coordinate system for corresponding calibration lines based on the reference markings, is further operable to determine the calibration coordinates in a 3D coordinate system based on the initial coordinates assigned to the portions of the reference markings.

20. A tangible, non-transitory, computer-readable media having software for three dimensional (3D) printing encoded thereon, the software, when executed by a hardware processor, operable to:
record, by the hardware processor, calibration image data for a plurality of time intervals when a laser projects laser light in a laser plane for a calibration area that includes a rotatable surface at a plurality of rotation states, the rotatable surface for a plurality of positions on a vertical track, an interior surface of a 3D printing device, and reference markings associated with the rotatable surface and the interior surface, the calibration image data includes calibration lines resulting from an intersection of the laser plane and each of the rotatable surface, the interior surface, and the reference markings;
record, by the hardware processor, object image data for a plurality of time intervals when the laser projects laser light in the laser plane for an object area that includes an object located on the rotatable surface, the rotatable surface for each rotation state, the rotatable surface for each position of the vertical track, the interior surface of the 3D printing device, and the reference markings associated with the rotatable surface and the interior surface, the object image data includes obstructed lines and object surface lines resulting from an intersection of the projected light in the laser plane with the rotatable surface, the interior surface, and the object; and
determine, by the hardware processor, a plurality of 3D object coordinates for the object in the 3D coordinate system based on deviations between calibration image data and the object image data.

21. The tangible, non-transitory, computer-readable media of claim 20, wherein the software, when executed by the hardware processor to determine the plurality of 3D object coordinates for the object, when executed by the hardware processor, is further operable to:
determine, by the hardware processor, the plurality of 3D object coordinates for the object in the 3D coordinate system based on deviations between the calibration lines of the image data and each of the obstructed lines and object surface lines of the object image data.
